(19) United States
(12) Patent Application Publication
(10) Pub. No.: US 2007/0194753 A1
(43) Pub. Date: Aug. 23, 2007

(54) Battery pack

(75) Inventors: Takashi Sumida, Osaka (JP); Masanori Yamakata, Osaka (JP); Tatsuya Kamada, Osaka (JP)

Correspondence Address: BIRCH STEWART KOLASCH & BIRCH, PO BOX 747, FALLS CHURCH, VA, 22040-0747, US

(73) Assignee: HITACHI MAXELL, LTD.

(21) Appl. No.: 11/707,944

(22) Filed: Feb. 20, 2007

(30) Foreign Application Priority Data
Feb. 20, 2006 (JP) 2006-041915

(51) Int. Cl. H02J 7/00

(52) U.S. Cl. 320/112

(57) ABSTRACT

A battery pack whose resin mold is hard to peel off from the outer peripheral surface of its unit cell and which can be manufactured at low cost is obtained. The battery pack includes a flat prismatic box-shaped unit cell and a resin mold formed on the outer peripheral side surface of the unit cell. In order to prevent the resin mold from easily peeling off, a rough surface portion 25 is formed on the outer peripheral side surface of the unit cell 1 by forming numbers of minute dots by laser beam machining on the outer peripheral side surface put in contact with the resin mold.

### BACKGROUND OF THE INVENTION

The present invention relates to a battery pack, in which a resin mold is formed on the outer peripheral surface of a unit cell.

JP 2003-7273 A (Paragraph No. 0020, FIGS. 1-2), JP 2003-7282 A (FIGS. 1-3), JP 2003-282037 A (FIG. 9) and JP 2003-282038 A (Paragraph No. 0017, FIG. 3) disclose battery packs, in which electrical components of a circuit board, a lead wire and so on are arranged on the outer peripheral surface of a unit cell, and the electrical components are integrated with the unit cell with a resin mold. Then, in these patent documents, the resin mold is prevented from peeling off from the outer peripheral surface of the unit cell by the following methods.

In JP 2003-7273 A, a sheet made to have a rough surface by corona discharge is stuck to the outer peripheral surface of the unit cell, and the resin mold is formed to cover the sheet. In JP 2003-7282 A, a gap is formed between the outer peripheral surface of the unit cell and a belt-shaped lead wire, which is bent and provided with a through hole, and the resin mold is formed to make a fused resin enter the gap.

In JP 2003-282037 A, a primer layer is formed on the outer peripheral surface of the unit cell, and the resin mold is formed on the exterior of the primer layer. In JP 2003-282038 A, an adhesive is applied to the outer peripheral surface of the unit cell, and the resin mold is bonded to the outer peripheral surface of the unit cell by the adhesive.

In JP 2003-7273 A, extra time is consumed for the parts control and the processing in manufacturing the battery pack to the extent that the sheet must be prepared and the rough surface processing and the processing of sticking the sheet to the unit cell are to be carried out, and this disadvantageously causes an increase in the manufacturing cost of the battery pack, a reduction in the manufacturing efficiency and so on.

In JP 2003-7282 A, extra labor is needed in manufacturing the battery pack to the extent of the processing of bending the lead wire in a complicated manner and forming the through hole, and this disadvantageously causes an increase in the manufacturing cost of the battery pack and so on. In addition, the resin mold that covers the lead wire must be increased in thickness to the extent that the lead wire is bent, and this hinders the compacting of the battery pack.

Also, in JP 2003-282037 A and JP 2003-282038 A, an increase in the manufacturing cost of the battery pack is caused because epoxy resin or the like must be prepared for the formation of the primer layer in JP 2003-282037 A and to the extent that the adhesive must be prepared in JP 2003-282038 A.

### SUMMARY OF THE INVENTION

An object of the present invention is to provide a battery pack capable of preventing the increase in the manufacturing cost and the like while preventing the resin mold from easily peeling off from the outer peripheral surface of the unit cell.

In order to achieve the above object, the present invention provides a battery pack including a flat prismatic box-shaped unit cell and a resin mold formed on the outer peripheral surface of the unit cell, wherein

the outer peripheral surface of the unit cell is at least partially formed to have a rough surface configuration in a portion put in contact with the resin mold.

In the battery pack of the present invention, the unit cell may be formed to have the rough surface configuration by forming a rough surface portion constituted of a plurality of minute dots formed on the outer peripheral surface of the unit cell by laser beam machining.

Moreover, in the battery pack of the present invention, it is acceptable to set the dimension of each of the minute dots to 0.04 to 0.1 mm and set the depth dimension of each of the minute dots to 0.02 to 0.05 mm.

Furthermore, in the battery pack of the present invention, it is acceptable to form each of the minute dots of a symbol or a letter and so that the minute dots do not overlap one another.

### BRIEF DESCRIPTION OF THE DRAWINGS

The present invention will be further described with reference to the accompanying drawings wherein like reference numerals refer to like parts in the several views, and wherein:

FIG. 1 is an exploded perspective view of an intermediate assembly prior to the formation of a resin mold;

FIG. 2 is a plan view of the intermediate assembly;

FIG. 3 is a perspective view of a battery pack; and

FIG. 4 is a transverse cross-sectional view of the battery pack.

### DETAILED DESCRIPTION OF THE PREFERRED EMBODIMENTS

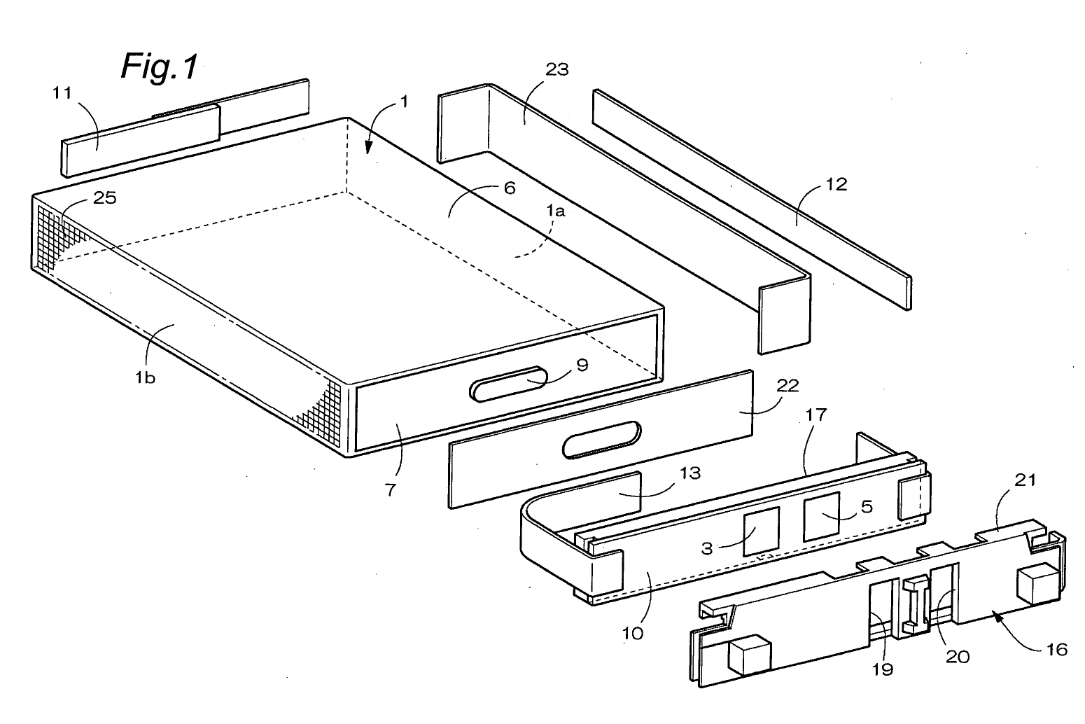

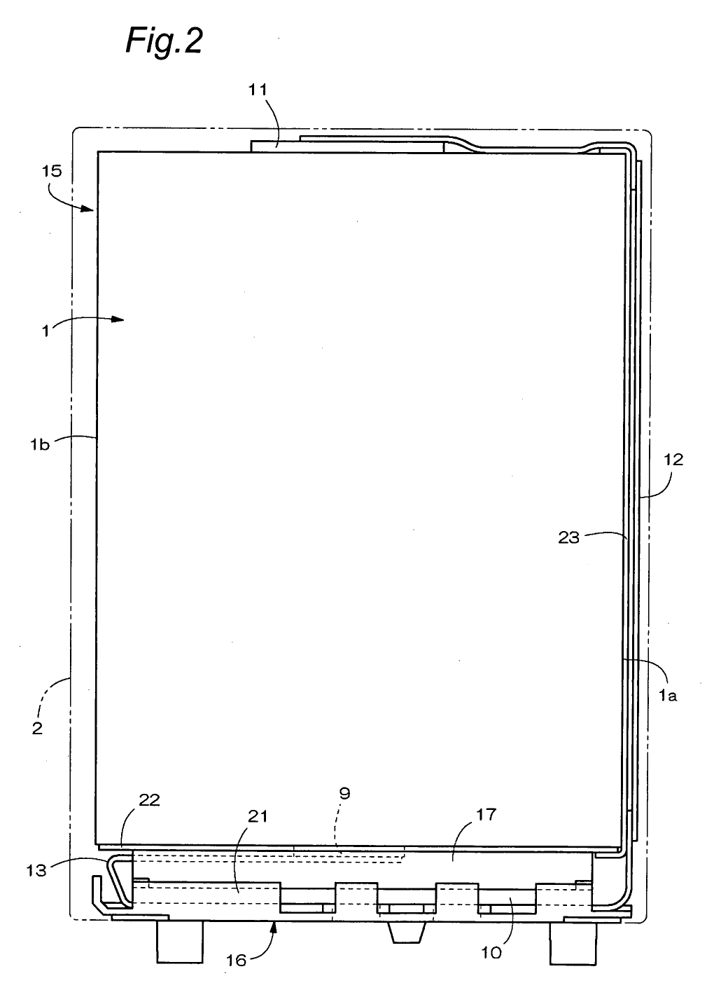

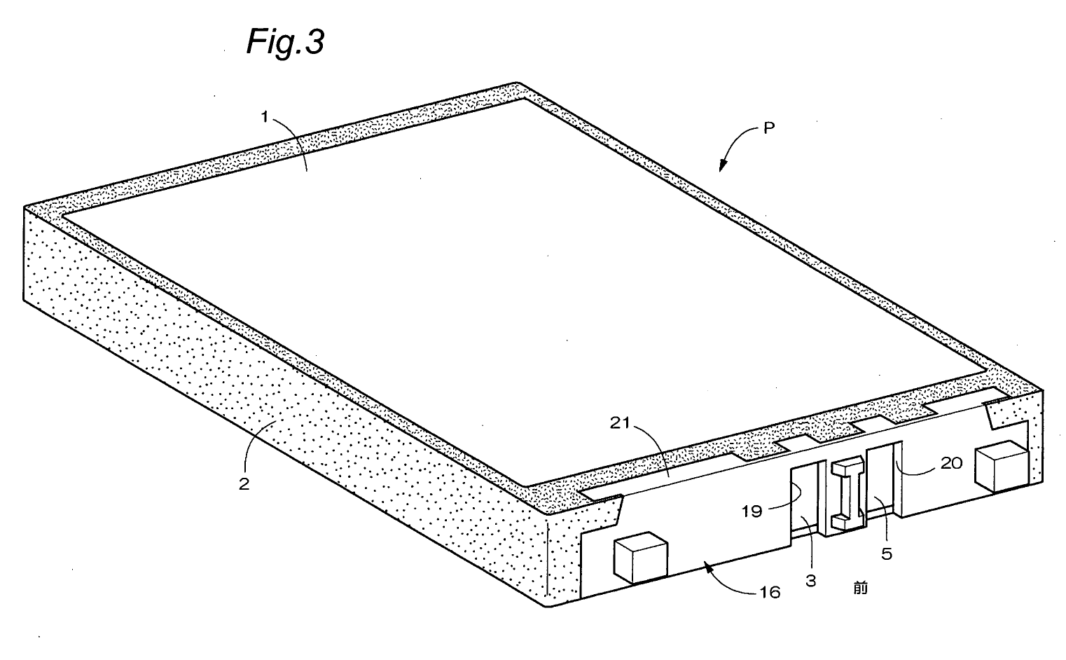

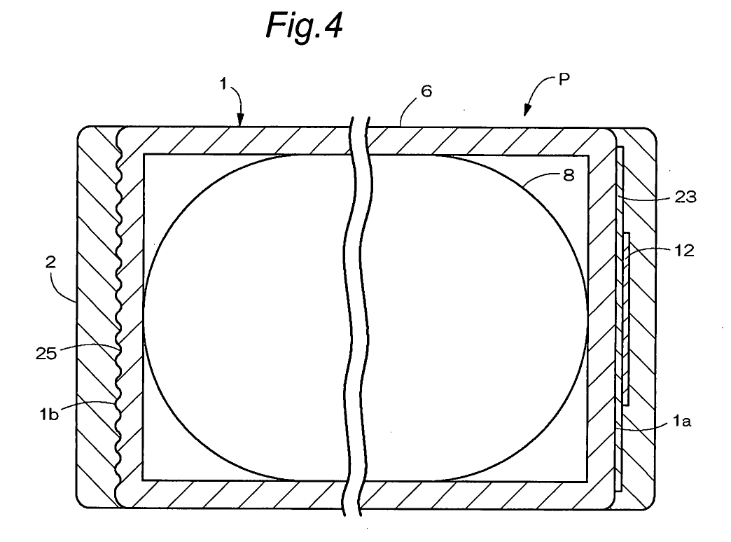

As shown in FIGS. 2 and 3, a battery pack P of one embodiment of the present invention includes a flat prismatic box-shaped unit cell 1 and a resin mold 2 formed on the outer peripheral surface of the unit cell 1. As shown in FIGS. 1 and 4, the outer peripheral surface of the unit cell 1 is at least partially formed to have a rough surface configuration in a portion put in contact with the resin mold 2. A method for forming the rough surface configuration includes formation of fine unevenness on the outer peripheral surface of the unit cell 1 by the processing of satin finish, orange peel finish, sand blasting or the like.

With regard to the fine unevenness, it is preferable to form a rough surface portion 25 on the outer peripheral surface of the unit cell 1 by laser beam machining of easy control since the strength of an enclosure can 6 of the unit cell 1 is lowered when the dimensions of the fine unevenness are excessively increased or the depth dimension becomes excessively deep.

In concrete, the rough surface portion 25 is formed of a plurality of (numbers of) minute dots. Each of the minute dots may be formed either dented or projected on the outer peripheral surface of the unit cell 1.

Although the configuration of each minute dot is not specifically limited but allowed to be a symbol such as “#”, “*”, “−”, “+”, or “@” or a letter such as “1”, “2”, “A”, “B”, “C” and cursive kana characters. Furthermore, the rough surface portion 25 may be formed by repetitively forming minute dots constituted of identical symbols and letters or by combining minute dots constituted of a plurality of symbols and letters or by combining minute dots constituted of meaningful letters such as the lot number or the article name.

It is preferable to set the size dimension of each of the minute dots to 0.04 to 0.1 mm in terms of workability and adhesion to the resin mold. Moreover, the contact area of the resin mold 2 with the unit cell 1 is increased and the resin mold 2 becomes hard to peel off from the unit cell 1 as the minute dots are increased in number with the pitch between mutually adjacent minute dots reduced or the depth dimension of the minute dots is increased, whereas the strength of the enclosure can 6 of the unit cell 1 is reduced on the other hand. Therefore, the pitch, the depth dimension, the width dimension and so on of the minute dots are set on the basis of tradeoff considerations between the adhesion of the resin mold 2 to the unit cell 1 and the strength of the enclosure can 6 of the unit cell 1.

In addition, it is preferable that the minute dots do not overlap one another. If the minute dots overlap one another, not only the strength of the enclosure can 6 is reduced but also the contact area of the resin mold 2 with the unit cell 1 is lowered, and the bonding strength of the resin mold 2 to the enclosure can 6 is also reduced.

For the above reasons, the pitch between the minute dots should preferably be set to 0.08 to 0.2 mm. When the pitch between the minute dots is smaller than 0.08 mm, not only the processing becomes difficult but also the minute dots might overlap one another. When the pitch between the minute dots is greater than 0.2 mm, the number of minute dots per unit area is reduced, and the bonding strength of the resin mold 2 to the enclosure can 6 is lowered.

Moreover, it is preferable that the depth dimension of the minute dots is set to 0.02 to 0.05 mm. When the depth dimension of the minute dots is smaller than 0.02 mm, the bonding strength of the resin mold 2 to the enclosure can 6 is lowered. When the depth dimension of the minute dots is greater than 0.05 mm, the strength of the enclosure can 6 is lowered by that much.

It is preferable that the minute dots are aligned in the lengthwise and crosswise directions, and it is further preferable that the intervals between the minute dots are reduced by arranging mutually adjacent minute dots in a zigzag form in order to increase the number of minute dots per unit area with regard to the point that the adhesion of the resin mold 2 to the outer peripheral surface of the unit cell 1 can be kept high and the strength of the enclosure can 6 of the unit cell 1 can be kept high.

When a belt-like plate-shaped lead wire (referred to as “long lead wire” hereinafter) 12 is placed on an outer peripheral side surface of the unit cell 1 and the lead wire 12 is covered with the resin mold 2, it is preferable that at least part of the outer surface of the lead wire 12 is formed to have a rough surface configuration in terms of preventing the resin mold 2 from easily peeling off from the unit cell 1.

Since the outer peripheral surface of the unit cell 1 is formed to have the rough surface configuration in the portion put in contact with the resin mold 2, the contact area of the resin mold 2 with the outer peripheral surface of the unit cell 1 is increased, and the resin mold 2 is hard to peel off from the outer peripheral surface of the unit cell 1 by that much. In addition, the arrangement obviates the need for preparing a sheet, an adhesive or the like to prevent the resin mold 2 from easily peeling off and carrying out a lead wire bending process or the like, so that an increase in the manufacturing cost of the battery pack P can be suppressed.

When the rough surface portion 25 is formed of minute dots by laser beam machining, it is allowed to easily process the outer peripheral surface of the unit cell 1 into a rough surface configuration and to properly control the width, depth and the like of the rough surface portion 25, so that a reduction in the strength of the outer periphery of the unit cell 1 due to the surface roughening can properly be suppressed.

When the outer surface of the lead wire 12 and so on are formed to have a rough surface configuration in addition to the outer peripheral side surface of the unit cell 1, the contact area of the resin mold 2 with the lead wire 12 and so on is increased by that much, and this further prevents the resin mold 2 from peeling off from the unit cell 1.

If the battery pack P is described more in detail, as shown in FIG. 3, the battery pack P is constructed of the flat prismatic box-shaped unit cell 1, electrical components arranged on an outer peripheral side surface of the unit cell 1, and the resin mold 2 that is formed on the outer peripheral side surface of the unit cell 1 and integrates the electrical components. The electrical components include external output terminals 3 and 5 that face the outside.

As shown in FIG. 1, the unit cell 1 has upper and lower surfaces formed to have a substantially flat surface and is finished to have a rectangular parallelepiped flat prismatic box-like configuration of which the vertical thickness dimension is smaller than the lengthwise dimension and the widthwise dimension. The resin mold 2 covers the electrical components, the front, rear, left and right outer peripheral side surfaces of the unit cell 1 and the peripheral portions of the upper and lower surfaces of the unit cell 1 and is formed of a polyamide based resin, for example. The resin mold 2 insulates the electrical components from the outside and protects the electrical components and the unit cell 1.

The unit cell 1 has an electrode body 8 (see FIG. 4) and an electrolyte sealed inside the enclosure can 6 and is constructed of a rechargeable secondary cell, or a lithium-ion battery in concrete. The opening front surface of the enclosure can 6 is plugged with a sealing plate 7, and a negative pole terminal 9 is provided at the center of the sealing plate 7.

The enclosure can 6 is formed by deep drawing of a plate material made of a metal such as aluminum or its alloy so that only the front surface is open. The sealing plate 7 is formed by press working of a plate material of aluminum alloy or the like and seam welded by laser to the periphery of the opening of the enclosure can 6. The electrode body 8 is constituted by winding a positive electrode that has LiCoO₂ as an active material and a negative electrode that has graphite as an active material in a roll form with interposition of a separator made of an insulative synthetic resin, and the whole body is formed pressed flat.

The electrical components include a laterally elongated circuit board 10 arranged on the front side surface of the unit cell 1, a thermal fuse 11 arranged on the rear side surface of the unit cell 1, a long lead wire 12 that connects both the components 10 and 11, and a belt-like plate-shaped short lead wire 13 that connects the negative pole terminal 9 with the circuit board 10. The short lead wire 13 is connected to the left-hand end portion of the circuit board 10 in a U-figured curved configuration, and the long lead wire 12 is connected to the right-hand end portion of the circuit board 10.

The circuit plate 10 has a protection circuit for limiting the charge and discharge currents of the unit cell 1. The external output terminals 3 and 5 are arranged horizontally side by side at the location slightly shifted to the slightly right-hand side from the horizontal center of the front surface of the circuit board 10. The external output terminals 3 and 5 execute input and output of charge and discharge currents to the unit cell 1 by being connected by contact with contact terminals of an external device such as a portable telephone or a charger.

The thermal fuse 11 is provided to cut off the charge and discharge currents of the unit cell 1 when the temperature of the unit cell 1 exceeds a set point, and its front side is connected to the rear surface of the enclosure can 6 (see FIG. 2). A heat resistant tape (not shown) is stuck to the outer surface of the thermal fuse 11. The vertical width dimension of the circuit board 10 and the thermal fuse 11 is slightly smaller than the vertical thickness dimension of the unit cell 1.

The lead wires 12 and 13 are formed by cutting a thin plate of a conductive metal such as aluminum into a belt-like shape. The vertical width dimension of the long lead wire 12 is smaller than the vertical thickness dimension of the unit cell 1. The vertical width dimension of the short lead wire 13 is smaller than the vertical width dimension of the circuit board 10. By temporarily assembling the electrical components on the outer peripheral surfaces of the unit cell 1, the intermediate assembly 15 of FIG. 2 is obtained. By forming the resin mold 2 on the intermediate assembly 15, the battery pack P shown in FIG. 3 is completed.

As shown in FIG. 1, the electrical components include a front cover 16 and a rear cover 17 with which the circuit board 10 is covered held from the front and the rear. The front and rear covers 16 and 17 were formed to have respective laterally elongated forms and molded with polycarbonate resin, for example, that is excellent in mechanical strength and insulation.

A pair of right and left windows 19 and 20 corresponding to the external output terminals 3 and 5 are provided in a penetrating form at the front cover 16. The rear cover 17 is fixed to the rear surface side of the circuit board 10 and insulates the circuit board 10 from the sealing plate 7 and the negative pole terminal 9. A pair of upper and lower engagement portions 21 and 21 for temporarily fixing the front cover 16 to the front side of the circuit board 10 are provided projecting rearward at the upper and lower ends of the front cover 16.

The rear cover 17 is stuck to the front surface of the sealing plate 7 of the unit cell 1 with an insulating both-sided tape 22. The long lead wire 12 is stuck to the right-hand side surface 1a of the unit cell 1 with an insulating double coated tape 23. The vertical width dimension of the double coated tape 23 is greater than the vertical width dimension of the long lead wire 12. That is, the resin mold 2 is partially bonded by part of the double coated tape 23 that protrudes vertically of the long lead wire 12.

As shown in FIG. 4, the rough surface portion 25 is formed in a rough surface configuration on the left-hand side surface 1b of the unit cell 1, and the rough surface portion 25 is put in contact with the resin mold 2. That is, numbers of minute dots are formed as the rough surface portion 25 by laser beam machining on the outer surface of the left-hand side surface 1b.

As shown in FIG. 1, the minute dots are arranged in places 0.5 mm inwardly of the end sides of the left-hand side surface 1b and formed into a “#” shape. The minute dots were set so that the size dimension was 0.6 mm, the pitch dimension between mutually adjacent minute dots was 0.12 mm and the depth dimension was 0.03 mm. It is noted that the configuration and the dimensions of the minute dots are not limited to the above-identified combination.

With the left-hand side surface 1b of the unit cell 1 formed to have the rough surface configuration, the contact area of the resin mold 2 with the left-hand side surface 1b of the unit cell 1 is increased, and the resin mold 2 is hard to peel off from the outer peripheral surface of the unit cell 1.

The assembling manner of the intermediate assembly 15 will be described next. The long lead wire 12 and the short lead wire 13 are connected to the right-hand end portion and the left-hand end portion, respectively, of the circuit board 10. The thermal fuse 11 is connected to the rear end of the long lead wire 12. The double coated tape 22 is stuck to the sealing plate 7 of the unit cell 1, and the double coated tape 23 is stuck to the right-hand side surface 1a of the unit cell 1.

After the short lead wire 13 is connected to the negative pole terminal 9, the short lead wire 13 is curved (see FIG. 1). The rear cover 17 is stuck to the double coated tape 22, and the long lead wire 12 is stuck to the double coated tape 23. The thermal fuse 11 is connected to the rear side surface of the unit cell 1.

Then, the engagement portions 21 and 21 of the front cover 16 are engaged with the circuit board 10 in a manner that the external output terminals 3 and 5 of the circuit board 10 face the windows 19 and 20 of the front cover 16. The front cover 16 is thus temporarily fixed to the front side of the circuit board 10, forming the intermediate assembly 15 shown in FIG. 2. Subsequently, the resin mold 2 shown in FIG. 3 is formed by means of a metal mold.

It is acceptable to form the rough surface portion 25 on the portion of the rear side surface of the unit cell 1 with which the resin mold 2 is put in contact, the outer surface of the long lead wire 12 or the like by laser beam machining or the like. Moreover, it is acceptable to form the rough surface portion 25 by forming numbers of minute dots or linear dents by laser beam machining or the like on the left-hand side surface 1b of the unit cell 1, the outer surface of the long lead wire 12 or the like. Moreover, it is acceptable to form the rough surface portion 25 by sand blasting or the like.

Although the present invention has been fully described by way of examples with reference to the accompanying drawings, it is to be noted that various changes and modifications will be apparent to those skilled in the art. Therefore, unless otherwise such changes and modifications depart from the spirit and the scope of the present invention, they should be construed as being included therein.

What is claimed is:

1. A battery pack comprising a flat prismatic box-shaped unit cell and a resin mold formed on an outer peripheral surface of the unit cell,
the outer peripheral surface of the unit cell being at least partially formed to have a rough surface configuration in a portion put in contact with the resin mold.

2. The battery pack as claimed in claim 1, wherein
the unit cell is formed to have the rough surface configuration by forming a rough surface portion constituted of a plurality of minute dots formed on the outer peripheral surface of the unit cell by laser beam machining.

3. The battery pack as claimed in claim 2, wherein
each of the minute dots has a dimension set to 0.04 to 0.1 mm, and each of the minute dots has a depth dimension set to 0.02 to 0.05 mm.

4. The battery pack as claimed in claim 2, wherein
each of the minute dots is formed of a symbol or a letter, and the minute dots do not overlap one another.
